(19) United States
(12) Patent Application Publication
(10) Pub. No.: US 2014/0163826 A1
(43) Pub. Date: Jun. 12, 2014

(54) TRACKED-VEHICLE CHARACTERISTIC TESTER (TCT)

(71) Applicant: Yona Ben-David, Ramat Efal (IL)

(72) Inventor: Yona Ben-David, Ramat Efal (IL)

(21) Appl. No.: 13/710,493

(22) Filed: Dec. 11, 2012

(51) Int. Cl. G01M 17/007

(52) U.S. Cl. CPC G01M 17/007
USPC 701/51; 701/32.8; 701/99

(57) ABSTRACT

The invention relates to a device and method for testing simultaneously and dynamically multiple dynamic systems of a track-based vehicle.

### FIELD OF THE INVENTION

The present invention relates to testing dynamic parameters of track-based vehicles such as tractors, snowmobile, bulldozers, excavators, and the like.

### BACKGROUND

Tracked-based vehicles include bulldozers, excavators, snowmobile, and tractors.

The transfer of power to tracked-based vehicle is accomplished by a drive or principal wheel, or drive sprocket, driven by the engine.

Currently, in order to assure the quality of tracked-based vehicles manufacturing and to check the specifications of the dynamic components of the tracked-based vehicles every component is dismounted and tested individually using specific equipment for each component.

There is an unmet need for testing tracked-based vehicles which lack the disadvantages of current testing.

### SUMMARY OF THE INVENTION

Currently, no equipment or method is available to check all necessary and critical dynamic components of a tracked-based vehicle once it is mounted and assembled in the complete vehicle.

The present invention provides a device and a method for rapidly testing all the dynamic components of an assembled tracked vehicle.

In one aspect, the present invention relates to a track-based vehicle testing device (TCT) suitable for dynamically testing dynamic parameters of the vehicle. The device comprises: a flywheel; a flywheel shaft; coupling means arranged in the flywheel shaft adapted for coupling rotation of a principal wheel or sprocket wheel of the tracked-vehicle to the flywheel; a flywheel motion sensing means, adapted for sensing the rotational motion of the flywheel and producing a signal corresponding thereto.

In one embodiment of the invention, the main part of the shaft sits on two bearings and the coupling means and the sensor means are assembled to the shaft and the flywheel is assembled between the bearings.

In one embodiment of the invention, the flywheel has a pre-determined inertia level.

In one embodiment of the invention, the device comprising a laser pointer in the coupling means.

In one embodiment of the invention, the shaft comprise actuators for moving the shaft towards all axis X, Y, and Z to adjust to the position of the drive-sprocket of different types of tracked-vehicles.

In one embodiment of the invention, the shaft is mounted on a moving chassis.

In one embodiment of the invention, the device further comprises a brake assembly that can brake rotational movement of the flywheel.

In one embodiment of the invention, the shaft further comprises a pulley or sprocket at its distal side to allow connection to a calibration device.

In one embodiment of the invention, the coupling means comprises an adapter.

In one embodiment of the invention, the flywheel shaft comprises the coupling means mounted at its proximal end.

In one embodiment of the invention, comprises a flywheel inertia ring.

In one embodiment of the invention, the device is for testing engine parameters selected from the group consisting of engine power, wheel thrust force, engine torque, engine speed, mechanical loses; brake parameters selected from the group consisting of left/right braking force, braking balance left to right, braking efficiency, brake distance, brake time, parking/emergency brakes; automatic transmission parameters selected from the group consisting of gear slip, thrust peak per gear, gear ratio, engine speed peak, shift time; steering parameters selected from the group consisting of functionality and efficiency; and/or instrument parameters selected from the group consisting of speedometer and odometer.

In one embodiment of the invention, the device further includes remote control means, for allowing the testing system to be operated from distance.

In another aspect, the present invention relates to a method of testing parameters of a tracked-vehicle using the device of the invention. The method comprises the steps of:

releasing the chain from the tracked-vehicle,
adjusting each TCT device unit to the position of left and right drive sprockets,
connecting the coupling means of device to the sprocket,
running and/or braking the engine following a set of predetermined instructions;
measuring tracked-vehicle parameters by sensing means connected to the device measuring the rotation motion of the flywheel; computing, comparing the data from each device and displaying and/or recording the parameters performance.

In one embodiment of the invention, after measuring tracked-vehicle parameters the results are compared with best mode reference.

In one embodiment of the invention, the device is used for testing engine parameters selected from the group consisting of engine power, wheel thrust force, engine torque, engine speed, mechanical loses; brake parameters selected from the group consisting of left/right braking force, braking balance left to right, braking efficiency, brake distance, brake time, parking/emergency brakes; automatic transmission parameters selected from the group consisting of gear slip, thrust peak per gear, gear ratio, engine speed peak, shift time; steering parameters selected from the group consisting of functionality and efficiency; and instrument parameters selected from the group consisting of speedometer and odometer.

In one embodiment of the invention, the method comprises calibration of the device prior to its use.

### BRIEF DESCRIPTION OF THE DRAWINGS

The invention is herein described, by way of example only, with reference to the accompanying drawings.

FIG. 1 shows two units of the Tracked-vehicle Characteristic Tester (TCT) device assembled to the drive sprocket of the tracked-vehicle from both sides thereof;

FIG. 2 shows a schematic view of the tracked-vehicle Characteristic Tester (TCT) device according to one embodiment of the invention;

FIG. 3 shows another schematic view of the tracked-vehicle Characteristic Tester (TCT) device from a different point of view, according to one embodiment of the invention;

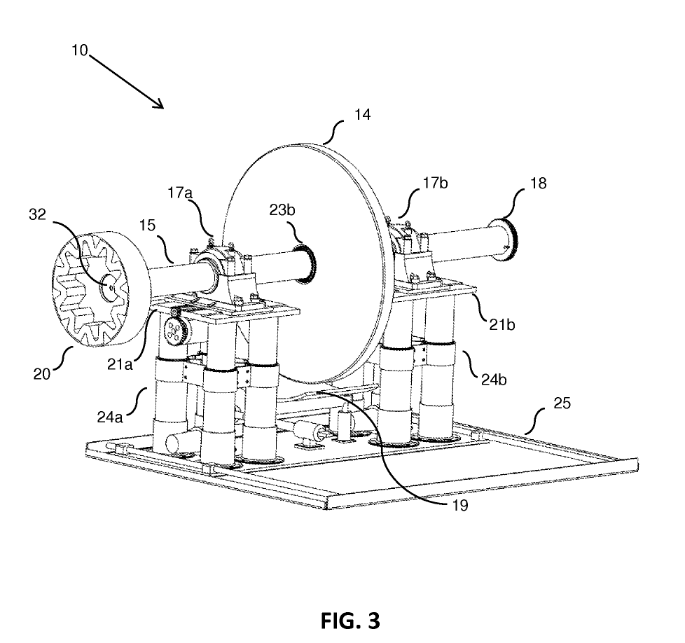

FIG. 4 shows a schematic view of the Tracked-vehicle Characteristic Tester (TCT) calibration device according to one embodiment of the invention;

FIG. 5 shows a schematic view of the Flywheel inertia ring according to one embodiment of the invention.

### BRIEF DESCRIPTION OF THE INVENTION

The present invention relates to tracked-vehicle Characteristic Tester (TCT), or to a device according to the invention suitable for measuring dynamically and quantitatively performance of dynamic parameters in track-based vehicles or caterpillar tracks such as tractors, snowmobile, bulldozers, excavators, earth moving machinery, military tank and the like (collectively called herein “tracked-based vehicle or tracked-vehicle”).

The TCT device is a one multi-function system that is designed to test simultaneously and dynamically, a plurality of dynamic parameters of a tracked-vehicle. Of advantage, there is no need of disassembling any components of the tracked-vehicle in order to test the parameters individually.

Today's testing procedures take days and require the use of different equipment. In contrast, two TCT units' which are deployed on each side of the tracked-vehicle can test a plurality of parameters automatically e.g. in less than one hour.

TCT device comprises a flywheel; a flywheel shaft; coupling means arranged in the flywheel shaft adapted for coupling rotation of a principal wheel or sprocket wheel to the flywheel; a flywheel motion sensing means, adapted for sensing the rotational motion of the flywheel and producing a signal corresponding thereto.

Advantageously, the TCT coupling means can contain a precision laser pointer for indicating the exact center of the sprocket.

### DESCRIPTION OF EMBODIMENTS

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The present invention relates to Tracked-vehicle Characteristic Tester (TCT), or a device according to the invention for measuring quantitatively, simultaneously and dynamically dynamic parameters of tracked-vehicles. Typically, TCT includes means for recording the performance of the various parameters and the results thus obtained.

TCT and the records thus obtained are of value in tracked-vehicle factories, in tracked-vehicle repair and maintenance establishments, in diagnostic and service stations, and in establishments carrying out periodical checks of tracked-vehicles.

TCT and records are of value in tracked-vehicle factories to assure quality control at the end of the production line of the manufacturing companies. Also, TCT allows creating a database containing all the benchmarked (blueprint) data of different tracked-vehicle performance for future reference.

Contrasted with most conventional means for establishing and measuring few dynamic parameters of tracked-vehicle performance, the TCT device can test simultaneously and dynamically multiple dynamic systems comprising, but not limited to, the engine power; thrust; torque; engine speed; mechanical losses; automatic and manual transmissions; brakes force per side; braking balance; braking efficiency; braking fading; steering functionality and efficiency and instruments accuracy.

Contrasted with most conventional means for establishing and measuring few dynamic parameters of tracked-vehicle performance, in which the motor is removed from the tracked-vehicle for testing and when testing takes about 3-4 days, TCT device does not require disassembling any components of the tracked vehicle in order to test them individually and can test multiple dynamic systems within hours.

Contrasted with most conventional means in which the tracked-vehicle to be tested must be driven onto the test apparatus (typically housed in a pit), two TCT units can be deployed, one on each side of the tracked-vehicle.

According to the present invention, for TCT operation only the tracked-vehicle chain is delinked. The TCT is connected to the drive sprocket of the tracked-vehicle using coupling means, such as a custom adapter, present in TCT.

In one embodiment of the invention, the TCT coupling means contains a laser pointer allowing the TCT to align directly and precisely to the sprocket. The coupling means is located in the proximal end of a shaft. The distal end of the shaft contains a sensor that measures the angular acceleration. Also, mounted to the shaft is a flywheel, having a pre-determined inertia. By keeping the inertia (mass and shape) of the system constant, the TCT records the acceleration at a very high sampling frequency and derives a clean and steady graphical layout showing the changes of force over changes in rational velocity of the flywheel (acceleration and deceleration).

The term “proximal end” herein, relates to the end proximal to the tracked-vehicle wherein the term “distal end” relates to the end distal to the tracked-vehicle.

In one embodiment of the invention, the TCT uses a custom algorithm that compares the calculated force measurements and the engine speed. Based on the comparison, the TCT derives a precise report with all the parameters that have been tested and calculated.

The TCT is designed to be adjusted to many types of tracked-vehicle. The TCT allows degrees of freedom towards every axis (X, Y, Z).

In one embodiment of the invention, the TCT is mechanically built in a way that the movement is synchronized by a series of electrical and pneumatic actuators and motors that are computer controlled. The computer control allows the TCT to be operated with the use of remote controls.

In one embodiment of the invention, in order to connect to the tracked-vehicle, the TCT has an adapter that is tailor-made by the type of tracked-vehicle to be tested. In one embodiment, the adapter is made out of a steel casting that has a hard rubberized core (coupling) that prevents wear on the steel parts of the tracked vehicle sprocket and in the adapter itself.

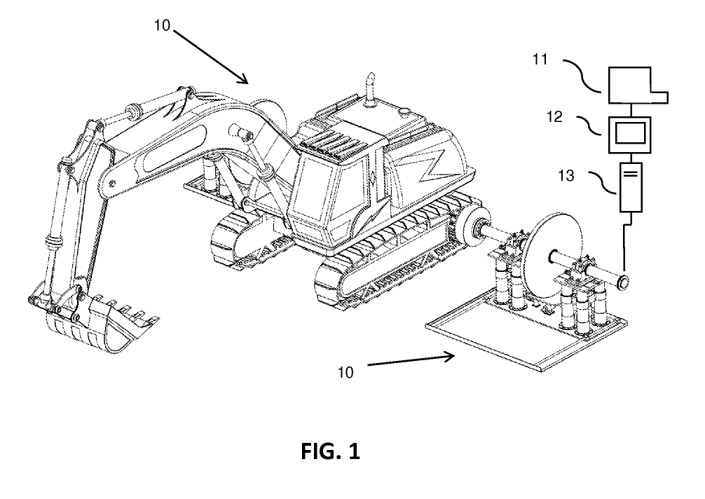

Now referring to FIG. 1, there are shown left and right TCT (10) assemblies mounted on a tracked vehicle. The tracked vehicle being tested lies on the ground. The unit works on each side of the tracked vehicle. The TCT is equipped with a computer (13), a screen (12) and a printer (11).

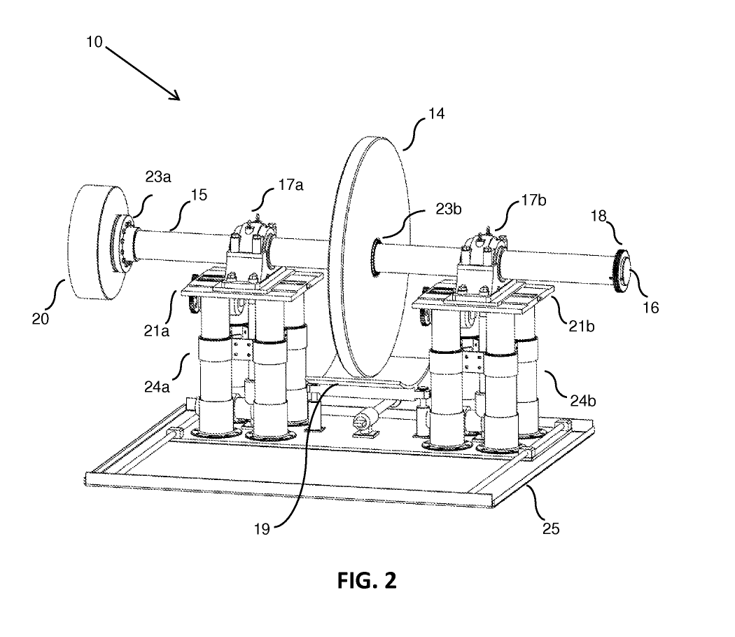

Now referring to FIG. 2, there is shown one TCT (10) unit that connects to one side of the tracked vehicle. The main part of the shaft sits on two bearings (17a, 17b) and has the Flywheel (14), adapter (20), pulley or sprocket (18) and sensor (16) assembled to it. The adapter (20) is located at the proximal end of a shaft (15) and connects the drive sprocket to the shaft (15). Each bearing (17a, 17b) is mounted on a moving chassis (21a, 21b). The moving chassis, is a steel assembly that allows degrees of freedom towards all axis (X,Y,Z) and comprises electric motors, actuators, and jacks (24a, 24b). A steel plate (25) connects the bearing to the moving chassis (frame). The flywheel (14) creates the inertia needed. The sensor (16) samples the position of the shaft and gives out an angular speed and acceleration read out. The TCT holds a brake assembly (19) that stops the rotational movement. A laser pointer (32), that is present in the adapter, lights the sprocket and allows the TCT to align directly and precisely to the sprocket. Locking assemblies (23a, 23b) locks the various components to the shaft. The bearings (17a, 17b) allow the shaft to rotate. Pulley or sprocket (18) can connect to a calibration unit (40) via a chain or belt (26).

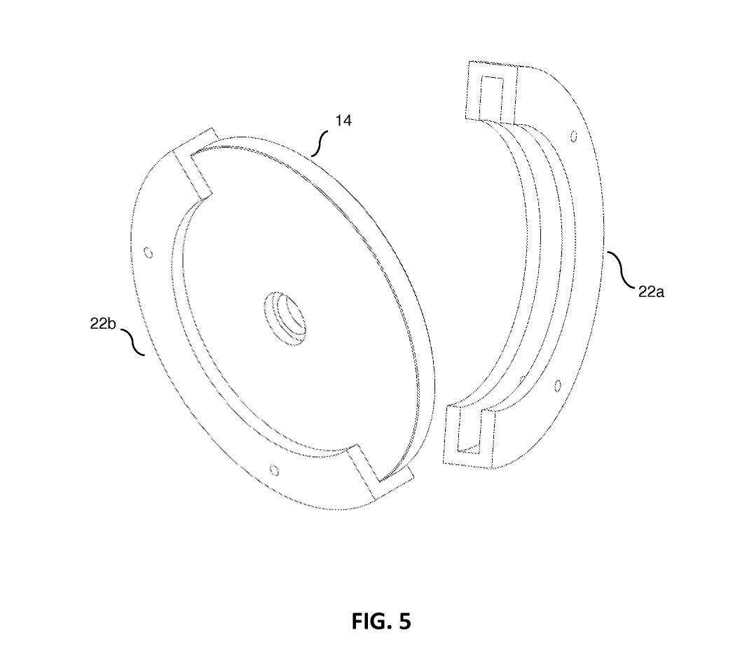

Now referring to FIG. 5 there is shown an inertia ring (22a, 22b). The ring allows adding mass to the flywheel (14) and changes its inertia.

In one embodiment, the moving chassis comprises electric motors, actuators, and jacks, pillar legs adapted to move the chassis and shaft together with the adapter and the flywheel on z axis (up and down), left and right on x axis, backward and forward on y axis.

The movement along x, y, and z axis allow to adjust to the position of the drive-sprocket of different types of tracked-vehicles.

In certain embodiments, the TCT can be adjusted prior to each use, in order to accommodate to tracked-vehicle wheels of various sizes.

In one embodiment: a locking assembly locks the adapter to the shaft; the sprocket or pulley is used for connecting the calibration system; the sensor samples the position to determine accelerations; a steel plate connects the bearing to the moving chassis (frame); a brake assembly consists of a steel structure, electric or pneumatic actuators and a friction material and it pushes against the flywheel in order to brake it; a motor or actuator pushes the brake assembly; a motor or actuator moves the part of chassis/frame back and forward; a motor or actuator moves part of the chassis up and down. The rest of the elements are made of steels of various compositions. The flywheel dimensions are determined by the power of the engine that is being tested. Same rule applies for the inertia rings.

In one embodiment of operation, the engine creates a rotational force that is conveyed through a transmission to the drive wheel of the tracked vehicle. The drive wheel connects to a type of coupling that is connected to a shaft and rotates at the same speed as the drive wheel. To the shaft a sensor and a flywheel are connected (e.g. using tapper locks). The shaft is held by a moving chassis (XYZ directions) and by two or more bearings (allowing rotational movement of the shaft). Once the shaft and flywheel rotate, they obtain a certain momentum. The TCT measures the acceleration and deceleration of the flywheel and calculates the exact forces that are acting upon it, thus leading to a precise indication of the power that is delivered through the engine and transmission.

In one embodiment of the TCT operation, every parameter that is checked is derived from the change of velocity (accelerations) and ratios between left and right side. The person testing the tracked-vehicle sits in the tracked-vehicle. The TCT device is adapted to receive rotation from any drive sprocket of the tracked-vehicle by the custom adapter of the tracked-vehicle. The motor drives the TCT's flywheel rotation via the adaptor. The motor can reach up to 2000 horsepower, about 1000 horsepower for each side.

In one embodiment of the testing Procedure: the tracked-vehicle drives in through a set path between the two TCTs (This sets the first alignment); Each TCT unit adjusts to the position of the drive-sprocket on each side of the tracked-vehicle using the laser guided precision (this sets the second alignment); the chain of the tracked-vehicle is released; the adapter of the TCT is connected to each sprocket; a technician runs the engine/and/or brakes following a set of predetermined instructions; the TCT gives the final results of all the tests that are conducted; each TCT unit returns to its original position; the chains of the tracked-vehicle are re-linked; the tracked-vehicle drives out.

In one embodiment, measurements are carried out as follows: All of the above procedures occur after both TCT units (left and right) align; using laser guided alignment, and are connected to the drive sprockets of the tracked vehicle through the adapter. The rotary motion of the engine output is carried through the transmission and by the adapter to the shaft and flywheel. Every step of the procedure inflicts changes to the rational velocity of the flywheel (acceleration and deceleration) that is measured by the sensors. The obtained data is computed by the computer and for each parameter or step the relevant values are displayed in the units that are preferred (example: English or Metric). The computer computes the acceleration and includes all the mathematical algorithms in order to calculate the specifications needed essentially as described in U.S. Pat. No. 4,158,961 incorporated herein by reference. When the procedure is finished the computer creates a graphical data output that contains all the computed data which is printed out on paper. The computer saves each test and builds a database that is used for statistical analysis and for validating the condition and specifications of the prototype. Pre-Checks: System checks of all the sensors, connectors, motors, controllers and computer. Make sure that everything is working properly.

The following functions can be tested by TCT:
In the engine:
   Engine power (horsepower/kW)
   Wheel thrust force (kgf)
   Engine torque (kgm/Nm/foot pound force) (as required)
   Engine speed (RPM)
   Mechanical loses (kW/horsepower)
In the brakes:
   Left/Right braking force (kgf)
   Braking balance/left to right (percentage)
   Braking efficiency (percentage)
   Brake distance (m)
   Brake time (s)
   Parking/Emergency brakes (kgf)
In the automatic Transmission
   Gear slip (percentage)
   Thrust peak per gear (kgf)
   Gear ratio (ratio)
   Engine speed peak (RPM per gear)
   Shift time (sec)
In the steering
   Functionality (right to left and left to right deviation in percentage)
   Efficiency (percentage left and right)
   In the instrument
   Speedometer (km/h)

### Odometer (m)

In an exemplary procedure:

### 1. Engine Power

1.1 Engage first gear and accelerate the engine and transmission up to the gear before last (for example if there are 4 speeds then to the 3^{rd}) and to a cruising speed (example 40 km/h). The accelerator pedal should be pushed to the maximum of its range.
   2. Mechanical losses
2.1 Accelerate the engine and transmission to maximum speed and RPM.
2.2 Engage the transmission to a Neutral gear (idler) and release the accelerator pedal.
2.3 Wait until the engine and transmission stop completely.

### 3. Transmission

3.1 Accelerate the engine and transmission to maximum speed and RPM.

### 4. Brakes

4.1 At the maximum speed apply full force to the brake pedal and release.
4.2 Repeat stage 4.1 until reaching a complete stop of transmission output.

### 5. Steering

5.1 Accelerate the engine and transmission to a cruising speed and RPM.
5.2 Turn the steering wheel or steering lever all the way to one side.
5.3 Same as 5.2 but to opposite side.
5.4 Repeat 5.2 & 5.3 2 times.
5.5 Repeat 5.1-5.4 but this time only half way to each side.

### 6. Speedometer

6.1 Accelerate the engine and transmission to a pre-determined speed (example; 40 km/h) and hold it for 4-5 seconds.

### 7. Engine Hours

7.1 There will be a clock to validate the accuracy of the engine hour counter.

In on embodiment of the invention, calculations and results are visualized graphically and are then compared to the initial graphical output of the TCT computer algorithm. In one embodiment, the acceptable deviation between the blue print (best mode reference) and the actual measurements is about 5%.

In one aspect, the invention provides a method of testing parameters of a tracked-vehicle using the device according to the invention.

The method comprises adjusting the device to the position of a drive sprocket of a tracked-vehicle, releasing the chain, connecting the coupling means of device to the sprocket, running and/or braking the engine following a set of predetermined instructions; measuring tracked-based vehicle parameters by sensing means connected to the device measuring the rotation motion of the flywheel; and displaying and/or recording the parameter performance.

After measuring tracked-vehicle parameters the results are compared with the calculated measurements and based on the comparison a report with all the tested parameters is derived.

The calculations that are made using the formula (second law of Newton):

Force=Mass×Acceleration

Moment=Inertia×Angular Acceleration

The results of the test can be obtained as a printed report. In one embodiment, the report shows a graphical performance of each tested system. It is possible to obtain the graph report along with a graph of an optimal and maximal mode reference (blueprint). The graph report is compared to a graph prototype. To the best of applicant's knowledge, this kind of graphical reports is not currently available.

All the results of new vehicles can be automatically collected in the data base of the tested tracked-vehicle and the report can show scan graphs of the original blueprint versus the tested analysis of the vehicle.

TABLE 1
Exemplary technical data (weight and measurements) of the
range of vehical parameters that can be tested by TCT:

| | | |
|---|---|---|
| TCT TRACKED VEHICLE'S | | |
| PARAMETERS | MIN | MAX |

| Weight of tracked vehicle | 5,000 | kg | No limit | |
|---|---|---|---|---|
| Measurable engine output | 200 | hp | 2000 | hp |

| | | | |
|---|---|---|---|
| Total brake force | — | 10,000 | kgf |

| | | | | |
|---|---|---|---|---|
| Measurable engine speed | 600 | rpm | 10,000 | rpm |

| | | | |
|---|---|---|---|
| Thrust force | — | 6750 | kgf |
| STD accuracy | +/−0.2% | | |

Exemplary display of results: Scan graphs will be taken from the best results obtained at the beginning of new vehicles testing and that will be printed and used as a blueprint. The acceptance tolerance is then decided. Later on, the results of the test include statements of the appropriate remarks. The report is stored in the database to be compared to the following examination of the vehicle and future statistics.

TCT has one or more of the following advantages:
Ideal to station at the end of the production line to assure quality control.
Gives the possibility to compare the manufacturing blueprint to the vehicle being tested at the end of the production line.
The tests can be conducted without dismantling any dynamic systems of the tracked vehicle except releasing the chains, and consequently saving a great amount of time and work.
The duration of the test is less than 10 minutes, not including the adaptation of the TCT to the tracked vehicle.
This is the only way to test all dynamic systems of the tracked vehicle simultaneously.
The system can be operated in a very simple manner: Only two people are required and any trained technician can learn how to operate the system.
According to the size of the vehicle, the TCT will adapt itself automatically, remotely controlled without taking out screws or dismantling components.
Advantageously the device, allows testing many parameters in up to one hour (including connection of the TCT to the tracked-vehicle).

The TCT primary design guide-line is accuracy. In order to achieve this, a calibration procedure was developed using precise measuring equipment. Typically, the calibration procedure is carried out annually to assure constant accurate results. The calibration device for the testing of TCT is similar as that described in patent number U.S. Pat. No. 7,493,805 B2 incorporated herein by reference.

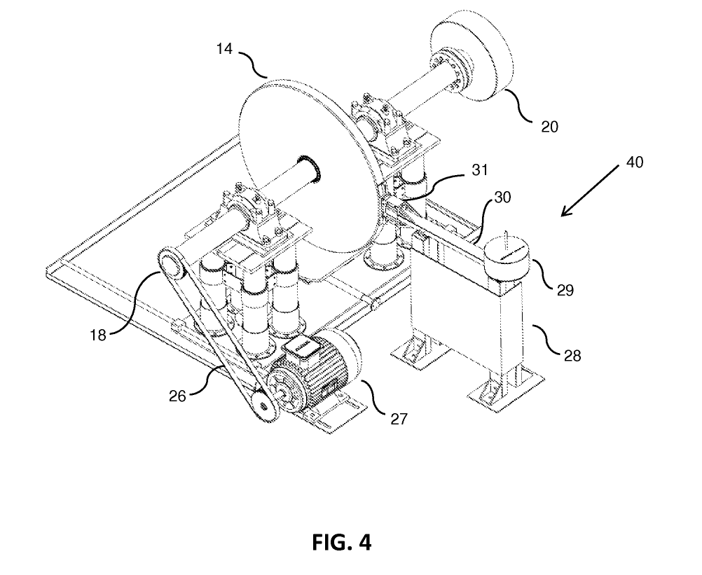

Now turning to FIG. 4, the calibration device (40) comprises an electric motor (27) to rotate the shaft and thereby the flywheel (14) (until maximal rotation is achieved); a pneumatic piston (31) used to apply forces to brake the flywheel; calibration weights (29) for setting the load cell (located under the steel arm and calibration weights) to a complete zero; a rail/steel arm (30) which holds the piston and the weights; an electronic power meter (or load cell) to measure the compressive forces operating on the flywheel; and a sprocket (18) and chain (26) (or pulley (18) and belt (26)) which allows connection of the TCT to the calibration unit. The calibration device comprises a chassis (28) to hold structural components.

Calibration is carried out to get a precise reading of the inertia of the system, thus leading to very accurate calculations that can be achieved when the accurate accelerations are known (for acceleration readings a sensor are used). Calibration is carried out without the tracked-vehicle connected. The end result of the calibration process makes the TCT computer algorithm accurate.

In an exemplary calibration procedure:
1. The load cell is set using a precise set of weight (reset of load cell weight).
2. The flywheel is accelerated to a predetermined speed using an external 20 KW electric motor that is connected by a chain and sprocket (or pulley and belt) to the distal end of the shaft.
3. The motor is shut down.
4. A brake force is applied to the flywheel outer rim using a pneumatic piston.
5. An accurate reading of the brake force is given by the load cell.

The force measured is used to precisely calculate the inertia of the system.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A testing device suitable for testing dynamic parameters of a tracked-vehicle comprising:
a. a flywheel; a flywheel shaft; coupling means arranged in the flywheel shaft adapted for coupling rotation of a principal wheel or sprocket wheel of the tracked-vehicle to the flywheel; a flywheel motion sensing means, adapted for sensing the rotational motion of the flywheel and producing a signal corresponding thereto.

2. The testing device according to claim 1, wherein the main part of the shaft sits on two bearings and the coupling means and the sensor means are assembled to the shaft and, wherein the flywheel is assembled between the bearings.

3. The testing device according to claim 1, wherein the flywheel has a pre-determined inertia level.

4. The testing device according to claim 1, comprising a laser pointer in the coupling means.

5. The testing device according to claim 1, wherein the shaft comprise actuators for moving the shaft towards all axis X, Y, and Z to adjust to the position of the drive-sprocket of different types of tracked-vehicles.

6. The testing device according to claim 1, wherein the shaft is mounted on a moving chassis.

7. The testing device according to claim 1, further comprising a brake assembly that can break rotational movement of the flywheel.

8. The testing device according to claim 1, wherein the shaft further comprises a pulley or sprocket at its distal side to allow connection to a calibration device.

9. The testing device according to claim 1, wherein the coupling means comprises an adapter.

10. The testing device according to claim 1, wherein the flywheel shaft comprises the coupling means mounted at its proximal end.

11. The testing device according to claim 1, further comprising a flywheel inertia ring.

12. The testing device according to claim 1, for testing engine parameters selected from the group consisting of engine power, wheel thrust force, engine torque, engine speed, mechanical loses; brake parameters selected from the group consisting of left/right braking force, braking balance left to right, braking efficiency, brake distance, brake time, parking/emergency brakes; automatic transmission parameters selected from the group consisting of gear slip, thrust peak per gear, gear ratio, engine speed peak, shift time; steering parameters selected from the group consisting of functionality and efficiency; and/or instrument parameters selected from the group consisting of speedometer and odometer.

13. The testing device, according to claim 1, further including remote control means, for allowing the testing system to be operated from distance.

14. A method of testing parameters of a tracked-vehicle using the device of any one of claim 1, comprising the steps of:
releasing the chain from the tracked-vehicle,
adjusting each device to the position of left and right drive sprockets,
connecting the coupling means of device to the sprocket,
running and/or braking the engine following a set of predetermined instructions;
measuring tracked-vehicle parameters by sensing means connected to the device measuring the rotation motion of the flywheel; computing, comparing the data from each device and displaying and/or recording the parameters performance.

15. The method according to claim 14, wherein after measuring tracked-vehicle parameters the results are compared with best mode reference.

16. The method according to claim 14, for testing engine parameters selected from the group consisting of engine power, wheel thrust force, engine torque, engine speed, mechanical loses; brake parameters selected from the group consisting of left/right braking force, braking balance left to right, braking efficiency, brake distance, brake time, parking/emergency brakes; automatic transmission parameters selected from the group consisting of gear slip, thrust peak per gear, gear ratio, engine speed peak, shift time; steering parameters selected from the group consisting of functionality and efficiency; and instrument parameters selected from the group consisting of speedometer and odometer.

17. The method according to claim 14, further comprising calibration of the device prior to its use.
